(19) United States
(12) Patent Application Publication
(10) Pub. No.: US 2019/0244243 A1
(43) Pub. Date: Aug. 8, 2019

(54) SCALABLE DECENTRALIZED DIGITAL AND PROGRAMMATIC ADVERTISING ANALYTICS SYSTEM

(71) Applicant: KR8OS, INC, Marina Del Rey, CA (US)

(72) Inventors: Samuel Goldberg, Santa Monica, CA (US); Samuel Kim, Venice, CA (US); Miguel Morales, Los Angeles, CA (US); Alexander Voloshko, Kyiv (UA); Dariusz Zacharczuk, Siedlce (PL); Chris Cohen, Marina Del Rey, CA (US)

(73) Assignee: KR8OS, INC, Marina Del Rey, CA (US)

(21) Appl. No.: 16/271,534

(22) Filed: Feb. 8, 2019

Related U.S. Application Data
(60) Provisional application No. 62/628,247, filed on Feb. 8, 2018.
(60) Provisional application No. 62/681,439, filed on Jun. 6, 2018.

(51) Int. Cl. G06Q 30/02; H04L 9/06

(52) U.S. Cl. CPC G06Q 30/0248; H04L 2209/38; H04L 9/0637

(57) ABSTRACT

Systems and methods for decentralized digital advertising analytics, including programmatic advertising analytics, to collect and verify advertising event data to detect errors and fraud.

### CROSS-REFERENCE TO RELATED APPLICATIONS

This application claims priority to U.S. Provisional Application No. 62/628,247, filed on Feb. 8, 2018, the contents of which are incorporated herein by reference. This application also claims priority to U.S. Provisional Application No. 62/681,439, filed on Jun. 6, 2018, the contents of which are incorporated herein by reference.

### TECHNICAL FIELD

The present disclosure generally relates to digital advertising analytics error and fraud detection.

### BACKGROUND OF THE INVENTION

Digital advertising is almost a $300 billion industry globally. However, due to a broken and inconsistent supply chain, over $50 billion annually is lost for advertisers and publishers due to fraud. Digital advertising commonly appears on mobile, internet, over-the-top (OTT), television, out-of-home digital, and videogame platforms, as well as other digital communication systems.

The supply chain in programmatic advertising operates in an opaque and fragmented manner among the 4-10 vendors typically required to handle the transfer of an advertisement from an advertiser for presentation to a consumer. Programmatic advertising is typically powered by an auction that occurs in real time each time a web page or mobile app is opened. These auctions are facilitated by specialized platforms enabling automated transactions. Without communication of data between each platform, data discrepancies are more than just expected, they may exceed 20%. As a result, malicious actors may infiltrate the programmatic advertising supply chain to engage in fraudulent activity, which can include illicit auction mechanics, identity theft, measurement inflation, and the like. Due to the lack of coordination and transparency, the fraud may be entirely undetected and involve parties unknown to the advertisers.

In a typical implementation of programmatic advertising, an ad request from a seller receives a bid response from a buyer, and the advertisement is supplied which eventually results in one impression, e.g., the advertisement is viewed once by a visitor, or displayed once on a web page. A fraudster may try to “steal” impressions by making an ad request that looks just like a non-fraudulent ad request. In that scenario, an unsuspecting buyer may respond to the fraudulent ad request and trigger supply of the advertisement but the fraudster does not display the advertisement to the agreed-upon viewer or web page. Nevertheless, the fraudster confirms that an impression did occur, requests payment, and is paid by the buyer unable to detect the fraud.

Many other types of fraud occur in connection with digital advertising systems, such as programmatic systems, as well. The advertising auction process between buyer and seller can be corrupted by bid caching and bid shading. Impressions can be fabricated utilizing click injection techniques and bot farms. Valuable domains can be spoofed. In the U.S., law enforcement has been pursuing fraudsters and private lawsuits have sought compensation for the resulting losses.

Rigorous and fair evaluations of advertising performance are urgently needed in the advertising industry to combat large scale errors and fraud. The advertising industry does not have a mechanism to allow data sharing among advertising supply-chain participants in an efficient, verifiable, immutable way.

Advertising industry supply-chain participants typically include advertisers, advertising agencies, demand-side platforms (DSPs), supply-side platforms (SSPs), exchanges, ad servers, publishers, data management platforms (DMPs) viewability solutions, anti-fraud solutions, and third-party verification systems. DSPs provide technology enabling advertisers to operate the bidding process. SSPs provide technology enabling publishers to monetize their properties by opening bids when a page is loading. Exchanges facilitate the auction between the DSPs and SSPs. Ad servers host and distribute advertisement content to websites, social media platforms, and mobile applications. Some ad servers are also referred to as “campaign management platforms” (CMPs) and may be used to facilitate buying inventory, setting up advertising campaigns, monitoring results, and calculating performance metrics.

Publishers own properties that contain ad space (inventory) where an advertiser could display an advertisement. Data management platforms (DMPs) aggregate data and generate audience segments for advertisers to use for more specific consumer targeting. Third party verification systems provide additional layers of analysis to enable advertisers to better understand the delivery of their advertisements and detect, for example, fraud, brand safety, and viewability.

Existing advertising analytics solutions rely on centralized platforms, e.g., data centers controlled by a single party. Due to the centralization, typically no transparency is provided to advertising industry participants regarding the source or composition of the advertising data, leaving them to rely on the integrity of the controlling party. This single point of failure presents risk to the participants. The industry is in need of a solution that allows for participants in advertising campaigns to maintain privacy but also have access to reliable metrics regarding the advertising events in which they participate.

FIG. 1 is a diagram illustrating differing databases among participants in a prior art digital and programmatic advertising system. In a typical advertising campaign, advertisers 110, DSPs 120, SSPs 130, publishers 140, and others (not shown) keep separate records of their transactions involved in the campaign. An advertiser's database 112 stores information about the campaign that differs from the information stored in the DSP's database 122, the SSP's database 132, and the publisher's database 142. Certain aspects of the data stored in each database should match but conventional systems do not attempt to reconcile them. Where the data clearly does not match, it can be difficult, if not impossible, to determine whether the mismatch is due to processing errors, storage errors, asynchronous activity, hijacked resources, or other types of fraud.

### SUMMARY

An object of certain embodiments of the present invention is to provide a programmatic advertising analytics system with high availability and high fault tolerance to hardware failure and intentional misuse.

In accordance with an embodiment of the invention, a decentralized analytics system includes a plurality of data sources; a decentralized verification system; a routing system, connected to the plurality of data sources and the decentralized verification system, for routing transaction data from the plurality of data sources to the decentralized verification system; wherein the decentralized verification system compares the transaction data to identify matched transaction data and unmatched transaction data; and a storage, connected to the decentralized verification system, stores the matched transaction data and the unmatched transaction data.

In accordance with another embodiment of the invention, a decentralized analytics processing method includes the steps of: routing transaction data from a plurality of data sources to a decentralized verification system; comparing transaction data with a decentralized plurality of processing resources to identify matched transaction data and unmatched transaction data; and storing at least one of the matched transaction data and unmatched transaction data.

In accordance with a further embodiment of the invention, an analytics processing method includes the steps of: routing transaction data from a plurality of data sources to a verification system; comparing transaction data to identify at least one of matched transaction data and unmatched transaction data utilizing a zero-knowledge proof; and storing at least one of the matched transaction data and unmatched transaction data.

### BRIEF DESCRIPTION OF THE FIGURES

FIG. 1 is a diagram illustrating differing databases among participants in a prior art programmatic advertising system.

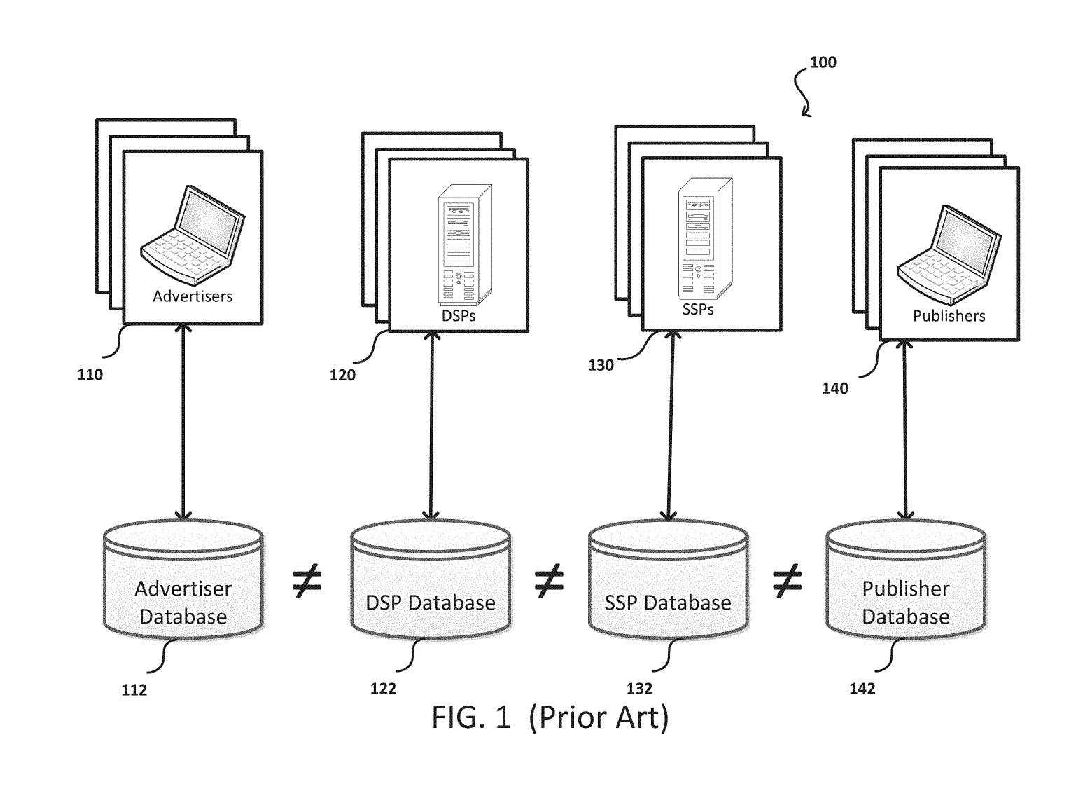

FIG. 2 is a diagram of a scalable, decentralized analytics system according to an exemplary embodiment of the present invention.

FIG. 3 is a flowchart of a processing methodology for a scalable, decentralized analytics system according to an exemplary embodiment of the present invention.

FIG. 4 is flowchart of a processing methodology for a scalable, decentralized programmatic advertising analytics system according to another exemplary embodiment of the present invention.

### DETAILED DESCRIPTION

The present disclosure is directed to systems and methods for providing fair and consistent verification of events among different participants in a series of interrelated transactions. Embodiments of the inventions described in this disclosure are advantageously implemented in a diverse variety of industries and applications including, but not limited to, programmatic advertising, food supply chains, pharmaceutical manufacturing, intermodal shipping, videogame analytics, and the like. In certain embodiments, item tracking data provided by different transaction participants can be compared and correlated to determine the true status of the tracked items. Erroneous and fraudulent data can be detected, rejected, and traced to the culpable or compromised transaction participant.

For illustrative purposes, the present invention will be described in the context of a programmatic advertising supply chain. As one of ordinary skill in the art will appreciate, implementation of the invention is not limited to that illustrative example.

Embodiments of the present invention provide systems and methods that reconcile data from multiple participants in a programmatic advertising supply chain. By comparing and contrasting data from multiple participants, the participants, especially advertisers and publishers, can obtain much more accurate information regarding the extent and efficacy of their respective efforts. Advertising expenditures can be traced to better determine return on investment and, preferably, more reliable data regarding the actual display of advertisements to viewers.

Embodiments of the present invention may include a clustering and routing mechanism, in which nodes are grouped as clusters and data is sharded by mapping data to different clusters, wherein those clusters come to a consensus within themselves and a final set of analytics is generated by aggregating the results of multiple clusters. The system combines a scalable way of routing transaction data and reaching consensus to verify transaction data, the corresponding transaction and/or related data.

With consistent and open sharing of programmatic advertising data, standards for defining advertising events can be programmatically codified and enforced to ensure that every participant in the supply chain is following the applicable rules, whether set by the advertising industry, an individual advertiser, or a group of such participants.

For each digital advertising campaign, e.g., a programmatic campaign, there are preferably at least three participants in the supply chain: a buyer (e.g., advertiser, agency, or DSP), a seller (e.g., SSP or publisher), and a third-party ad server (e.g., technology for serving and auditing the service of advertisements to a website, web browser, mobile application, or the like). In some circumstances, however, there could be only one or two supply chain participants. Data received from the supply chain participants are compared and correlated in order to reach a consensus on valid advertising event data. If data received from the participants match, a consensus on validity is automatically reached. When data from the participants does not match, a consensus mechanism is implemented to declare the validity or invalidity of the corresponding event and, unmatched data can be flagged, investigated, and categorized. Preferably, the identity of the participant that likely provided the non-matching data may be determined and recorded. In a preferred embodiment, the consensus mechanism is implemented as a smart contract on a blockchain to provide an impartial decision and an immutable audit trail. By sharing and matching data among supply chain participants, errors and fraud can be detected and reduced, if not eliminated entirely.

Preferably, granular advertising campaign-level signals are collected from tracking pixel, log-level or aggregate-level data. From such signals, multiple components of the data can be analyzed to identify matching data in order to reach a deterministic consensus. The criteria of interest for matching may vary depending on the identity of the participants and the types of transactions.

Advantageously, embodiments of the present invention may facilitate the identification of highly discrepant supply chain participants and of top performing placements according to supply chain congruence. Risky, fraudulent, honest, and/or compliant participants may be identified and tracked. Publishers are able to prevent loss of inventory and eliminate waste while obtaining transparency in their demand sources.

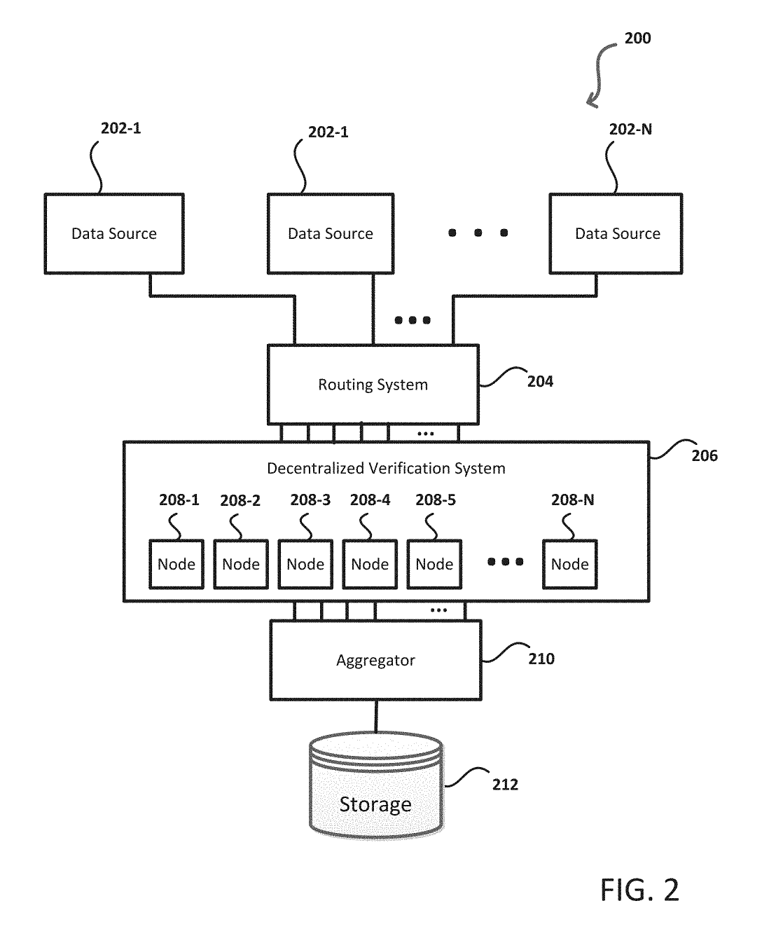

In FIG. 2, a scalable, decentralized analytics system 200 according to an exemplary embodiment of the present invention is shown. System 200 includes multiple data sources 202-1, 202-2 through 202-N; routing system 204; decentralized verification system 206, aggregator 210, and storage 212. Preferably, decentralized verification system 206 includes multiple processing nodes 208-1, 208-2, 208-3, 208-4, and 208-5 through 208-N. Optionally, routing system 204, aggregator 210, and/or storage 212 may be omitted.

Data sources 202-1, 202-2 through 202-N comprise conventional transaction data sources such as transacting parties, brokers, exchanges, third-party inspection services, payment processors, taxing authorities, and like transaction participants and observers. The data provided by each data source 202 may include transaction identification, participant identification, item identification, geographic location information, timing information, pricing information, payment information, other transaction details, and the like. The data provided by a data source 202 may be encrypted or digitally signed to establish the identity of the data source. Preferably, each item of data has a unique identifier (ID) that may be used for matching and checking against internal or external records. Optionally, the unique ID may be assigned by a participant, a data source 202, and/or routing system 204 and stored in internal or external storage.

Preferably, only authorized parties may qualify as a data source 202 or otherwise submit data via a data source 202. Authorization of a party to participate in system 200 may be provided with a separate security protocol such as a digital signature, cryptographic signature, or the like. Alternatively, a central registry of authorized participants may exist for the purpose of authorization and verification. Periodic or event-based verification of the identity of a party may be secured by the same or similar means, preferably via a data source 202 or routing system 204.

Routing system 204 is a computer system or software platform for routing data to decentralized verification system 204. Preferably, system 204 implements a consistent hashing algorithm to enable efficient scaling as the number of data sources 202, the amount of data, and the number of processing resources in system 206 changes. System 204 may include one or more load balancers, relayers, and exchanges. Preferably, a relayer is open source software run on a computing resource controlled by the data source 202 or routing system 204 that processes and packages the data for further transmission. Optionally, the relayer may encrypt or digitally sign the data to create an auditable marking associated with the data and/or the data source. Alternatively, other conventional data routing methodologies may be implemented, such as round-robin, or the like. Optionally, routing system 204 is integrated into one or more of data sources 202-1 through 202-N or decentralized verification system 206.

Decentralized verification system 206 preferably comprises one or more computer processing resources for matching data. In a preferred embodiment, system 206 includes multiple nodes 208-1 through 208-N, each comprising a computer processing resource running open source software. A node 208 may be a computer server, a group of computer servers, a virtual server, a processing thread, or the like. The verification nodes 208-1 through 208-N may be grouped into clusters such that each cluster preferably will contain at least 5 (five) nodes. Optionally, data may enter through any node 208 in system 206. Communications among nodes 208-1 through 208-N and between nodes 208 and routing system 204, aggregator 210, and/or storage 212 may be provided by standard communications protocols such as internet protocols, e.g., hypertext transfer protocol (http).

In a preferred embodiment, nodes 208-1 through 208-N periodically reach a consensus on the matching of input data using a byzantine fault tolerant smart contract on a blockchain. Optionally, nodes 208 may verify data by checking identification data in internal or external storage, or the like, e.g., a public blockchain and may store duplicate data across multiple nodes for high availability and fault tolerance.

In another preferred embodiment, nodes 208-1 through 208-N are controlled by a consortium of advertising industry bodies or other neutral parties to provide decentralized operation of the nodes. In an alternate embodiment, nodes 208-1 through 208-N are controlled by single entity or a centralized entity. In a still further embodiment, a node 208 implements a zero-knowledge proof algorithm to confirm the validity of a data match.

In a preferred operation of an embodiment of the invention, data sources 202-1 through 202-N provide transactional data related to a single or series of interrelated transactions to routing system 204. Routing system 204 implements a routing algorithm to route the transaction data to individual or groups of processing resources within decentralized verification system 206. System 206 attempts to identify matches among the transactional data provided and reach a consensus regarding the validity of such matches. The matching data and/or consensus data is provided by system 206 to aggregator 210 or to storage 212 directly for storage. Aggregator 210 preferably aggregates the matching data and/or consensus data with other data relating to the corresponding transactions and stores the aggregate data in storage 212.

In a preferred operation of an embodiment of the present invention, routing system 204 receives new data and determines which node or cluster of nodes to which the data should be routed by indexing from or hashing one or more fields in the data. System 204 preferably generates a consistent hash from the contents of the selected data field. Preferably, the hashing operation is completed by a relayer within system 204. Based on the hash results, system 204 forwards the data to the corresponding node 208 or cluster of nodes in decentralized verification system 206.

To provide scalability, the node network engaged in the consensus protocol is preferable organized into independent sub-groups of nodes (called “clusters”) grouping nodes so that incoming eventful data may be evenly distributed across different clusters (sets of nodes). Utilizing consistent hashing, events will be more evenly distributed among clusters of nodes. By adding more clusters to the network, more events per second may be supported.

In an alternate embodiment, to provide additional security, transaction data is sharded among sub-groups of nodes such that single sub-group of nodes will not process all data for any given dimension, parameter, transaction or the like, but rather will process a subset of data, to minimizes the impact of a sub-group of nodes being taken over by bad actors. By sharding data across clusters, it is more difficult for colluding nodes to affect the analytical results in significant ways, especially for high volume networks.

Optionally, a node 208 relays the data it receives to other nodes 208 in its cluster and the nodes 208 gossip about the incoming data with each other. Nodes 208 can have the capability to reach consensus outside of a smart contract by gossiping with other nodes (known as “off-chain consensus”) Conventional consensus mechanisms may be utilized such as proof-of-work, proof-of stake, Paxos, practical byzantine fault tolerance (PBFT) and the like. As a further alternative, each cluster of nodes 208 may come to a consensus using a byzantine fault tolerant smart contract on the blockchain. In a preferred embodiment, each cluster includes at least five (5) nodes 208, as it allows for there to be up to two (2) “bad” nodes in a given cluster while maintaining the integrity of the consensus mechanism.

After each cluster arrives at a consensus, the results of the analytics by that cluster may be stored in a database or other data structure, such as blockchain or the like. Alternatively, the data may also be hashed and the hash stored separate from the data. Preferably, the results are grouped by dimensions (e.g., campaign and channel ID), along with a set of metrics, (e.g., impressions, clicks, conversions).

Aggregator 210 combines the consensus results of all clusters for a related set of transactions utilizing a transcendent identifier (e.g., a campaign ID). The final results may be stored in storage 212 as a database or other data store, such as blockchain or the like. Alternatively, the final results may also be hashed and the hash stored in storage 212, along with or separate from the consensus results.

In an embodiment omitting aggregator 210, one or more of nodes 208 aggregates the matched and/or unmatched results and stores the results in storage 212.

In a further alternate embodiment, one or more of the transaction data, consensus results, aggregate data, and final results can be stored and queried in the nodes 208 themselves. That information can be verified by computing hashes and checking them against the pre-stored hashes in a blockchain.

In another alternate embodiment, decentralized verification system 206 is replaced with a processor implementing a zero-knowledge proof, e.g., a zero-knowledge succinct non-interactive argument of knowledge (zk-SNARK), a transparent zero-knowledge proof (zk-STARK), or the like. Transaction data from different sources are matched using a zero-knowledge proof to confirm that the match or lack of match was determined. The results can be stored directly in a blockchain in storage 212.

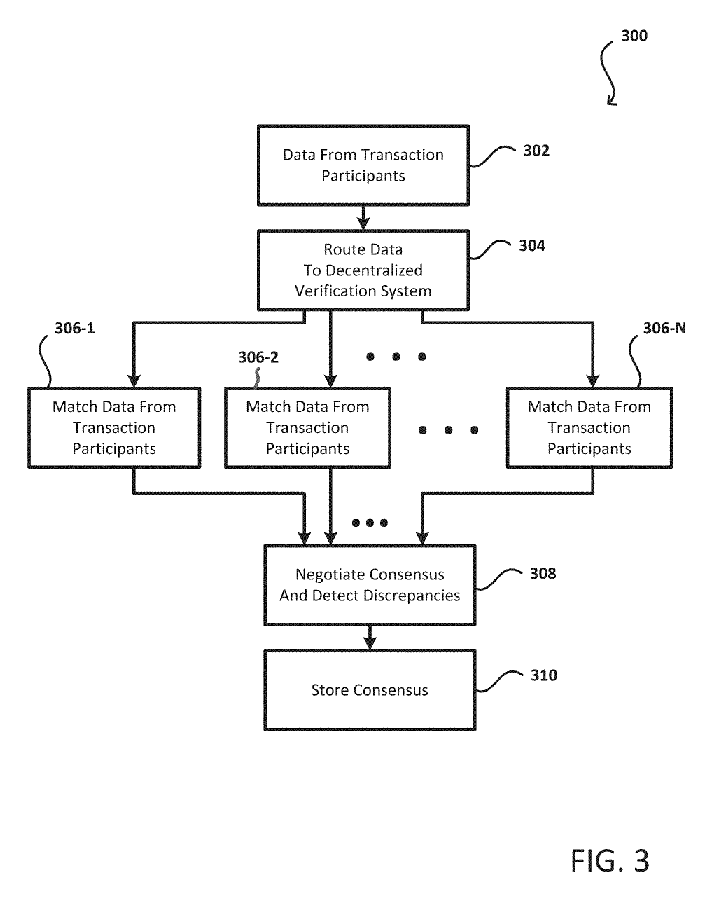

In FIG. 3, a flowchart of a processing methodology for a scalable, decentralized analytics system according to an exemplary embodiment of the present invention is shown. In step 302, data from multiple transaction participants are supplied. In this explanation, a “transaction” may be a single transaction or a series of interrelated transactions. In step 304, the data is routed to a decentralized verification system. In steps 306-1 through 306-N, computer processing resources, such as nodes, attempt to match the transaction data supplied by the multiple transaction participants in parallel or near-parallel calculation. Matching data is deemed to be potentially valid and unmatched data is deemed to be potentially invalid. In step 308, differing match data is subject to a consensus protocol to reach a consensus regarding the matched and unmatched data. Discrepancies from the consensus may optionally be recorded separately to identify one or more of the data at issue, the data source responsible for the data at issue, the other participants that provided the same or similar data, the node(s) that made the match or detected the lack of a match. In step 310, one or more of the transaction data, match data, consensus data, discrepancy data, or a representation of any of the foregoing are stored. For example, a hash of the foregoing data may be stored.

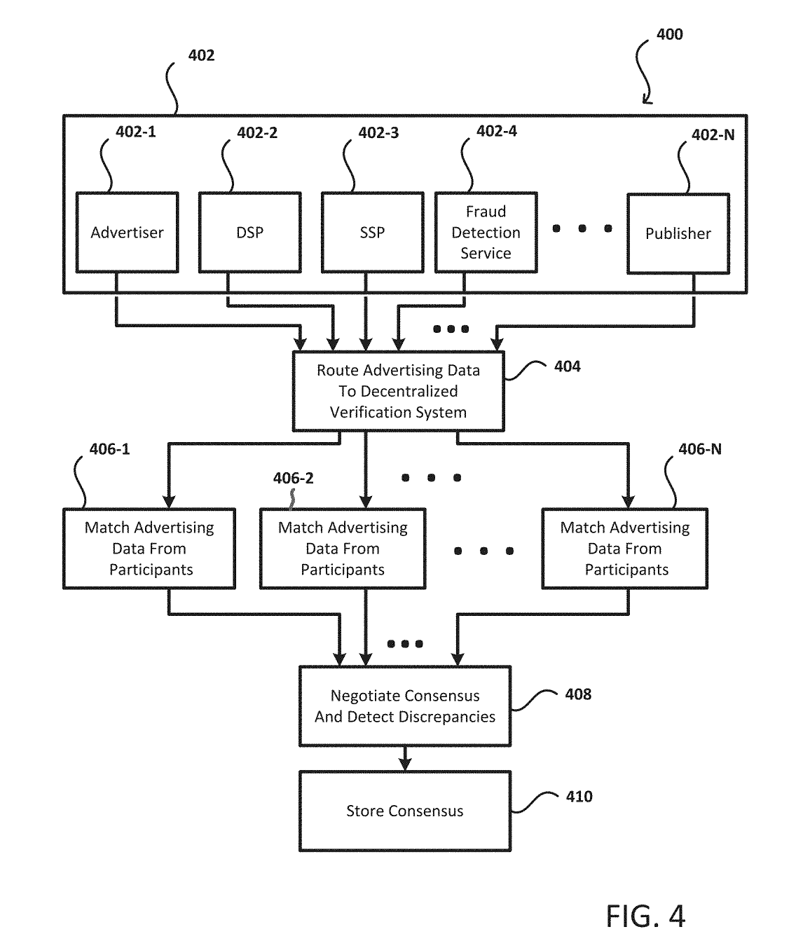

In FIG. 4, a flowchart of a processing methodology for a scalable, decentralized programmatic advertising analytics system according to another exemplary embodiment of the present invention is shown. In a programmatic advertising system the participant data preferably includes a session identifier, a device identifier, and/or an event identifier. When a participant wants to report an advertising transactional event, the corresponding data possessed by that participant is sent to the decentralized verification system, preferably via the routing system.

The steps of flowchart 400 function similar to their counterparts described in connection with FIG. 3. In step 402, at least three of advertiser 402-1, DSP 402-2, SSP 402-3, fraud detection service 402-4, publisher 402-N, and potentially numerous other programmatic advertising supply-chain participants synchronously or asynchronously provide data regarding an advertising campaign. Alternatively, there could be only one or two supply-chain participants. In step 404, the advertising data is routed to a decentralized verification system. In steps 406-1 through 406-N, computer processing resources, such as nodes, attempt to match the transaction data supplied by the multiple advertising campaign participants in parallel or near-parallel calculation. Matching data is deemed to be potentially valid and unmatched data is deemed to be potentially invalid. In step 408, differing match data is subject to a consensus protocol to reach a consensus regarding the matched and unmatched data. Discrepancies from the consensus may optionally be recorded separately to identify one or more of the data at issue, the data source responsible for the data at issue, the other participants that provided the same or similar data, the node(s) that made the match or detected the lack of a match. In step 410, one or more of the transaction data, match data, consensus data, and discrepancy data are stored.

The various implementations above are applicable in many different and varied operating environments, on one more electronic devices that incorporate integrated circuits, chips for processing and memory purposes. A system or method of the present disclosure also includes a number of the above exemplary systems working together to perform the same functions disclosed herein.

Example environments discussed herein for implementing aspects in accordance with various embodiments are primarily Web-based, as relate to Web services and cloud computing, but it should be appreciated that, although a Web-based environment is used for purposes of explanation, different environments may be used, as appropriate, to implement various embodiments. Client devices used to interact with various embodiments can include any appropriate device operable to send and receive requests, messages, or information over an appropriate network and convey information back to a user of the device. Examples of such client devices include personal computers, smart phones, handheld messaging devices, laptop computers, set-top boxes, personal data assistants, electronic book readers, and the like. The network can include any appropriate network, including an intranet, the Internet, a cellular network, a local area network, or any other such network or combination thereof. Components used for such a system can depend at least in part upon the type of network and/or environment selected. Protocols and components for communicating via such a network are well known and will not be discussed herein in detail. Communication over the network can be enabled by wired or wireless connections, and combinations thereof using communication component, such as discussed throughout this disclosure.

It should be understood that there can be several application servers, layers, or other elements, processes, or components, which may be chained or otherwise configured, which can interact to perform tasks as discussed and suggested herein. As used herein the term “data store” refers to any device or combination of devices capable of storing, accessing, and retrieving data, which may include any combination and number of data servers, databases, data storage devices, and data storage media, in any standard, distributed, or clustered environment. The application server can include any appropriate hardware and software for integrating with the data store as needed to execute aspects of one or more applications for the client device, handling a majority of the data access and business logic for an application. The application server provides access control services in cooperation with the data store, and is able to generate content such as text, graphics, audio, and/or video to be transferred to the user, which may be served to the user by the Web server in the form of HTML, XML, or another appropriate structured language in this example. The handling of all requests and responses, as well as the delivery of content between a client device and a resource, can be handled by the Web server. It should be understood that the Web and application servers are not required and are merely example components, as structured code discussed herein can be executed on any appropriate device or host machine as discussed elsewhere herein.

A data store can include several separate data tables, databases, or other data storage mechanisms and media for storing data relating to a particular aspect. The data store is operable, through logic associated therewith, to receive instructions from a server, and obtain, update, or otherwise process data in response thereto. In one example, a user might submit a request for one or more symbols of one or more securities. In this case, the data store may respond with the information about current values or precomputed data portions. The current values or precomputed data portions may also come from an index database for faster access, and may include a timestamp indicating current date and time for the data. The information then can be returned to the buffer areas and may be deployed by respective executable code that processes the data first to provide a risk assessment with the data.

Each server will include an operating system that provides executable program instructions for the general administration and operation of that server, and will include a non-transitory computer-readable medium storing instructions that, when executed by a processor of the server, allow the server to perform its intended functions. Suitable implementations for the operating system and functionality of the servers are known or commercially available, and are readily implemented by persons having ordinary skill in the art, particularly in light of the disclosure herein.

The environment in one embodiment is a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are described. Thus, the depictions of various systems and services herein should be taken as being illustrative in nature, and not limiting to the scope of the disclosure.

Various aspects can be implemented as part of at least one service or Web service, such as may be part of a service-oriented architecture. Services such as Web services can communicate using any appropriate type of messaging, such as by using messages in extensible markup language (XML) format and exchanged using an appropriate protocol such as SOAP (derived from the “Simple Object Access Protocol”). Processes provided or executed by such services can be written in any appropriate language, such as the Web Services Description Language (WSDL). Using a language such as WSDL allows for functionality such as the automated generation of client-side code in various SOAP frameworks.

Most embodiments utilize at least one network that would be familiar to those skilled in the art for supporting communications using any of a variety of commercially-available protocols, such as TCP/IP, FTP, UPnP, NFS, and CIFS. The network can be, for example, a local area network, a wide-area network, a virtual private network, the Internet, an intranet, an extranet, a public switched telephone network, an infrared network, a wireless network, and any combination thereof.

In embodiments utilizing a Web server, the Web server can run any of a variety of server or mid-tier applications, including HTTP servers, FTP servers, CGI servers, data servers, Java servers, and business application servers. The server(s) also may be capable of executing programs or scripts in response requests from user devices, such as by executing one or more Web applications that may be implemented as one or more scripts or programs written in any programming language, such as Java®, C, C# or C++, or any scripting language, such as Perl, Python®, or Tool Command Language (TCL), as well as combinations thereof. The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices will also include a number of software applications, modules, services, or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets), or both. Further, connection to other computing devices such as network input/output devices may be employed.

Storage media and other non-transitory computer readable media for containing code, or portions of code, can include any appropriate media known or used in the art, including storage media and communication media, such as but not limited to volatile and non-volatile, removable and non-removable media implemented in any method or technology for storage of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to store the desired information and which can be accessed by the a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

1. A decentralized analytics system comprising:
a plurality of data sources;
a decentralized verification system;
a routing system, connected to said plurality of data sources and said decentralized verification system, for routing transaction data from said plurality of data sources to said decentralized verification system;
wherein said decentralized verification system compares the transaction data to identify matched transaction data and unmatched transaction data; and
a storage, connected to said decentralized verification system, to store the matched transaction data and the unmatched transaction data.

2. The decentralized analytics system of claim 1, wherein said decentralized verification system comprises a plurality of computer processing nodes.

3. The decentralized analytics system of claim 2, wherein said plurality of computer processing nodes verifies the matched transaction data via a consensus protocol.

4. The decentralized analytics system of claim 2, wherein said plurality of computer processing nodes verifies the unmatched transaction data via a consensus protocol.

5. The decentralized analytics system of claim 2, further comprising an aggregator interposed between said decentralized verification system and said storage.

6. The decentralized analytics system of claim 2, wherein said routing system further comprises a relayer.

7. The decentralized analytics system of claim 2, wherein said plurality of data sources includes an advertiser and a publisher.

8. The decentralized analytics system of claim 7, wherein said plurality of data sources includes a demand side platform and a supply side platform.

9. A decentralized analytics processing method comprising the steps of:
routing transaction data from a plurality of data sources to a decentralized verification system;
comparing transaction data with a decentralized plurality of processing resources to identify at least one of matched transaction data and unmatched transaction data; and
storing at least one of the matched transaction data and unmatched transaction data.

10. The decentralized analytics processing method of claim 9, further comprising the step of verifying the matched transaction data via a consensus protocol.

11. The decentralized analytics processing method of claim 9, further comprising the step of verifying the unmatched transaction data via a consensus protocol.

12. The decentralized analytics processing method of claim 9, wherein the step of routing comprises consistent hashing of a first transaction data to select at least one of said decentralized plurality of processing resources for processing of said first transaction data.

13. The decentralized analytics processing method of claim 9, wherein the step of storing comprises storing a hash of the transaction data in a blockchain data structure.

14. The decentralized analytics processing method of claim 9, wherein the transaction data includes at least one of a session identifier, a campaign identifier, and an advertising impression.

15. An analytics processing method comprising the steps of:
routing transaction data from a plurality of data sources to a verification system;
comparing transaction data to identify at least one of matched transaction data and unmatched transaction data utilizing a zero-knowledge proof; and
storing at least one of the matched transaction data and unmatched transaction data.

16. The decentralized analytics processing method of claim 15, wherein the step of storing comprises storing a hash of the transaction data in a blockchain data structure.
